(19) United States
(12) Patent Application Publication
(10) Pub. No.: US 2025/0284316 A1
(43) Pub. Date: Sep. 11, 2025

(54) ELECTRONIC DEVICE AND TOUCH MALFUNCTION DETECTION METHOD

(71) Applicant: Samsung Electronics Co., Ltd., Suwon-si (KR)

(72) Inventors: Changmin CHOI, Suwon-si (KR); Byungjai IM, Suwon-si (KR); Hansang LEE, Suwon-si (KR); Yonggil HAN, Suwon-si (KR); Jihoon KOO, Suwon-si (KR); Minho KIM, Suwon-si (KR); Sunmi ROH, Suwon-si (KR); Sangil YOON, Suwon-si (KR); Miju LEE, Suwon-si (KR); Sangman LEE, Suwon-si (KR); Seungho LEE, Suwon-si (KR); Yeonho JO, Suwon-si (KR)

(21) Appl. No.: 19/219,346

(22) Filed: May 27, 2025

Related U.S. Application Data
(63) Continuation of application No. PCT/KR2023/018241, filed on Nov. 14, 2023.

(30) Foreign Application Priority Data
Dec. 20, 2022 (KR) 10-2022-0179605
Dec. 27, 2022 (KR) 10-2022-0186105

(51) Int. Cl. G06F 1/16; G06F 3/01; G06V 40/20

(52) U.S. Cl. CPC G06F 1/163; G06F 3/017; G06V 40/28; G06F 2200/1637

(57) ABSTRACT

An electronic device is provided. The electronic device includes a display including a touch screen, a proximity sensor configured to detect an approaching external object, a motion sensor configured to detect movement of the electronic device, memory storing one or more computer programs, and a processor communicatively coupled to the display, the proximity sensor, the motion sensor, and the memory, wherein the one or more computer programs include computer-executable instructions that, when executed by the processor cause the electronic device to use the proximity sensor to identify whether the electronic device is worn on the arm of a user, in case that the electronic device is worn on the arm of the user, use the motion sensor to identify a movement of the electronic device, identify whether the identified movement of the electronic device belongs to a designated movement, in case that the identified movement belongs to the designated movement, identify whether the angle at which the electronic device is tilted belongs to a designated angle range, determine, at least based on whether the angle at which the electronic device is tilted is within the designated range, that the electronic device is in a touch misrecognition state, and in case that the electronic device is in the touch misrecognition state, refrain from executing an operation corresponding to a touch input detected on the display.

### CROSS-REFERENCE TO RELATED APPLICATION(S)

This application is a continuation application, claiming priority under 35 U.S.C. § 365 (c), of an International application No. PCT/KR2023/018241, filed on Nov. 14, 2023, which is based on and claims the benefit of a Korean patent application number 10-2022-0179605, filed on Dec. 20, 2022, in the Korean Intellectual Property Office, and of a Korean patent application number 10-2022-0186105, filed on Dec. 27, 2022, in the Korean Intellectual Property Office, the disclosure of each of which is incorporated by reference herein in its entirety.

### BACKGROUND

### 1. Field

The disclosure relates to an electronic device. More particularly, the disclosure relates to a wearable device which can be worn on a human body.

### 2. Description of Related Art

With development of wireless communication, processors, and software technology, various types of smart devices have been developed. Among smart devices, there is a wearable device capable of providing various functions while being worn on a user's body, and a wristwatch-type wearable device may be an example thereof.

The wristwatch-type wearable device may have a display disposed on a main body (or a body) and display time information and various applications through the display. The display of the wearable device may be a touch screen capable of detecting a touch input of the user, and may control an operation of the wearable device, such as execution of an application or changing of a watch face, according to a user input to the display.

The above information is presented as background information only to assist with an understanding of the disclosure. No determination has been made, and no assertion is made, as to whether any of the above might be applicable as prior art with regard to the disclosure.

### SUMMARY

A wearable device is used when a user wears the same on his or her body, and accordingly, other body parts may come into contact with a display by a movement of the user. For example, when the user performs an operation of crossing his or her arms while wearing the wearable device on one arm, the display may come into contact with an area of the other arm, and the wearable device may determine the same as a touch input and execute an operation (e.g., changing of a watch face according to detection a long touch) corresponding to the touch input. This is a touch malfunction which is irrelevant to the actual intention of the user, but it is not easy to accurately detect the touch malfunction because there may be a situation in which a touch input is actually detected on the display.

Aspects of the disclosure are to address at least the above-mentioned problems and/or disadvantages and to provide at least the advantages described below. Accordingly, an aspect of the disclosure is to provide a wearable device which can be worn on a human body.

Additional aspects will be set forth in part in the description which follows and, in part, will be apparent from the description, or may be learned by practice of the presented embodiments.

In accordance with an aspect of the disclosure, an electronic device is provided. The electronic device includes a display including a touch screen, a proximity sensor configured to detect an approaching external object, a motion sensor configured to detect a movement of the electronic device, memory storing one or more computer programs, and a processor communicatively coupled to the display, the proximity sensor, the motion sensor, and the memory, wherein the one or more computer programs include computer-executable instructions that, when executed by the processor, cause the electronic device to use the proximity sensor to identify whether the electronic device is worn on an arm of a user, in case that the electronic device is worn on the arm of the user, identify a movement of the electronic device, and identify whether the identified movement of the electronic device belongs to a designated movement, in case that the identified movement belongs to the designated movement, identify whether an angle at which the electronic device is tilted falls within a designated angle range, determine, at least based on whether the angle at which the electronic device is tilted is within the designated range, that the electronic device is in a touch misrecognition state, and in case that the electronic device is in the touch misrecognition state, refrain from executing an operation corresponding to a touch input detected on the display.

In accordance with another aspect of the disclosure, a touch misrecognition detection method of an electronic device is provided. The method includes using a proximity sensor to identify whether the electronic device is worn on an arm of a user, in case that the electronic device is worn on the arm of the user, using a motion sensor to identify a movement of the electronic device, identifying whether the identified movement of the electronic device belongs to a designated movement, in case that the movement belongs to the designated movement, identifying whether an angle at which the electronic device is tilted falls within a designated angle range, determining, at least based on whether the angle at which the electronic device is tilted is within the designated range, that the electronic device is in a touch misrecognition state, and in case that the electronic device is in the touch misrecognition state, refraining from executing an operation corresponding to a touch input detected on a display including a touch screen.

In accordance with another aspect of the disclosure, one or more non-transitory computer-readable storage media storing one or more computer programs including computer-executable instructions that, when executed by one or more processors of an electronic device individually or collectively, cause the electronic device to perform operations including a touch misrecognition detection method are provided. The operations include using a proximity sensor to identify whether the electronic device is worn on an arm of a user, in case that the electronic device is worn on the arm of the user, using a motion sensor to identify a movement of the electronic device, identifying whether the identified movement of the electronic device belongs to a designated movement, in case that the identified movement belongs to the designated movement, identifying whether an angle at which the electronic device is tilted falls within a designated angle range, determining, at least based on whether the angle at which the electronic device is tilted is within the designated range, that the electronic device is in a touch misrecognition state, and in case that the electronic device is in the touch misrecognition state, refraining from executing an operation corresponding to a touch input detected on a display including a touch screen.

Various embodiments of the disclosure can provide a method for detecting a touch misrecognition, which is irrelevant to a user's intention, by a wearable-type electronic device worn on the user's body and used.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIGS. 2A and 2B are perspective views illustrating an electronic device according to various embodiments of the disclosure;

FIG. 3 is an exploded perspective view illustrating an electronic device according to an embodiment of the disclosure;

FIG. 4 illustrates a state in which a user wears an electronic device according to an embodiment of the disclosure;

FIG. 5 is a block diagram illustrating an electronic device according to an embodiment of the disclosure;

FIG. 6 illustrates various sensors arranged in a main body of an electronic device according to an embodiment of the disclosure;

FIG. 7 is a flowchart illustrating a method for identifying whether an electronic device is worn according to an embodiment of the disclosure;

FIG. 8 illustrates a movement detection reaction of a motion sensor of an electronic device according to an embodiment of the disclosure;

FIG. 9 simply illustrates an angle at which the electronic device is oriented according to an embodiment of the disclosure; and

FIG. 10 is a flowchart illustrating a touch malfunction detection method of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

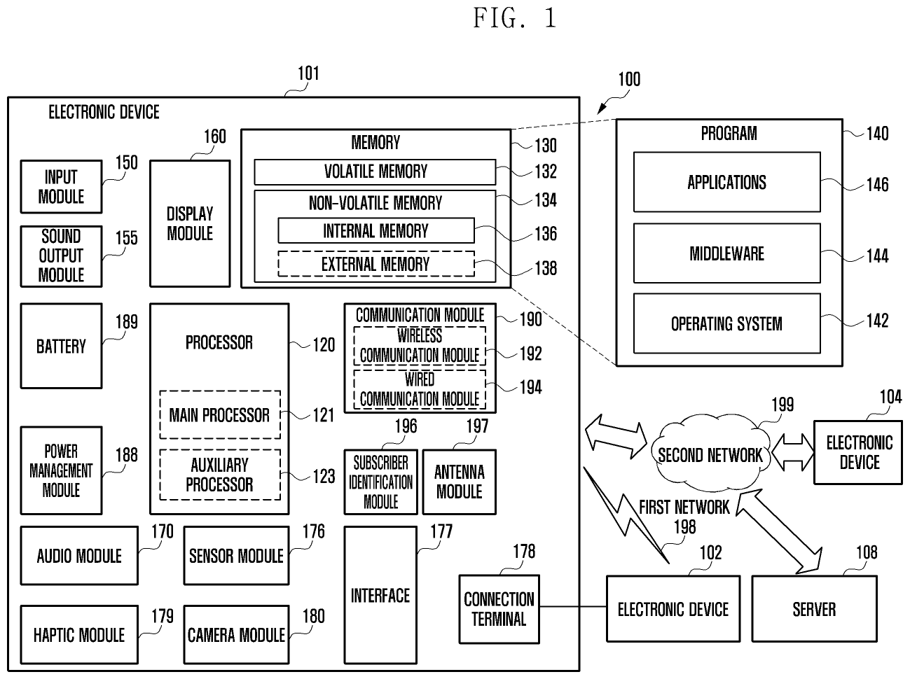

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave band)) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

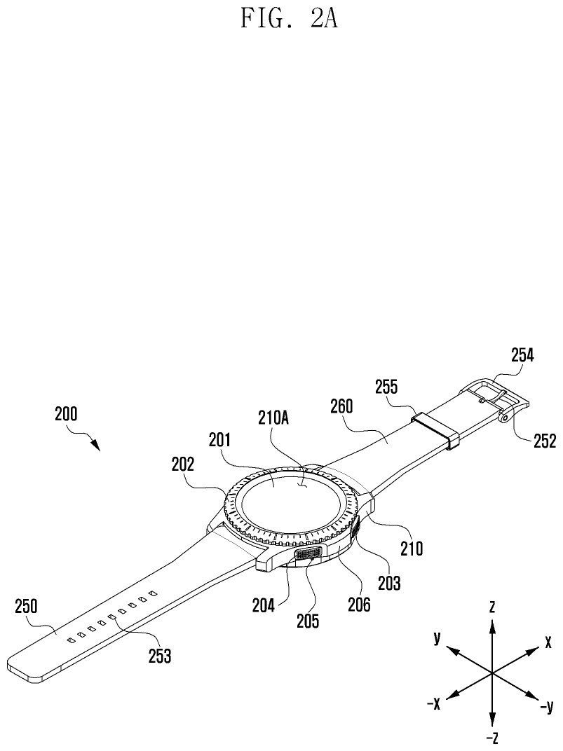

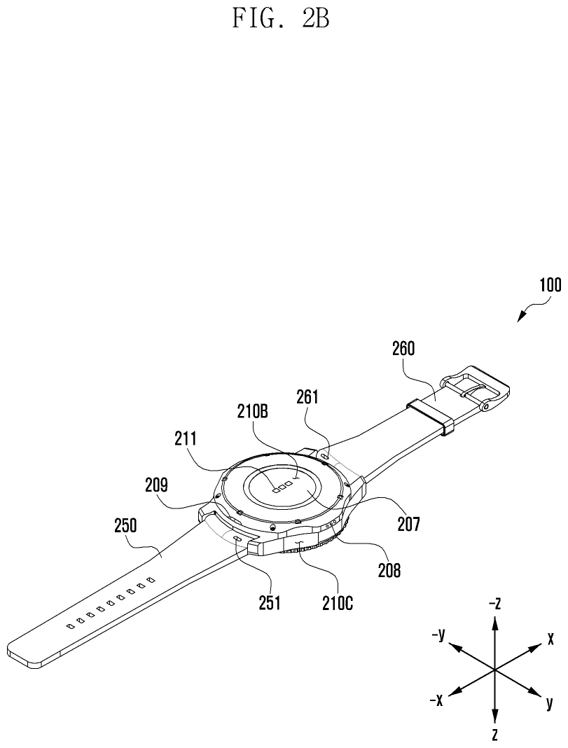

FIG. 2A is a perspective view illustrating an electronic device according to an embodiment of the disclosure, and FIG. 2B is a perspective view illustrating an electronic device according to an embodiment of the disclosure.

FIG. 2A illustrates a front surface of an electronic device, and FIG. 2B illustrates a rear surface of an electronic device.

Referring to FIGS. 2A and 2B, an electronic device 200 (e.g., the electronic device 101 of FIG. 1) according to an embodiment may include a housing 210 including a first surface (or a front surface) 210A oriented in a first direction (e.g., z-axis direction), a second surface (or a rear surface) 210B oriented in a second direction (e.g., −z axis direction) opposite to the first direction, and a side surface 210C surrounding a space between the first surface 210A and the second surface 210B, and binding members 250 and 260 connected to at least a part of the housing 210 and configured to allow the electronic device 200 to be detachably bound to a part of the body (e.g., wrist, ankle, or the like) of the user.

In an embodiment (not shown) of the disclosure, the housing 210 may also refer to a structuring forming a part of the first surface 210A, the second surface 210B, and the side surface 210C of FIG. 2A. According to an embodiment of the disclosure, the first surface 210A may be formed by a front plate 201 (e.g., a polymer plate or a glass plate including various coating layers) having at least a part which is substantially transparent. The second surface 210B may be formed by a rear plate 207 which is substantially opaque. The rear plate 207 may be formed by, for example, coated or colored glass, a ceramic, a polymer, a metal (e.g., aluminum, stainless steel (STS), or magnesium), or a combination of at least two thereof. The side surface 210C may be formed by a side bezel structure (or a side member) 206 that is coupled to the front plate 201 and the rear cover 207 and includes a metal and/or a polymer. In an embodiment of the disclosure, the rear cover 207 and the side bezel structure 206 may be integrally formed and include the same material (e.g., a metal material, such as aluminum). The binding members 250 and 260 may be formed by various materials and shapes. The binding members may be formed as an integral unit link and a plurality of unit links by fabric, leather, rubber, urethane, a metal, a ceramic, or a combination of at least two thereof such that the same can move with regard to each other.

According to an embodiment of the disclosure, the electronic device 200 may include at least one of a display 220, audio modules 205 and 208, a sensor module 211, key input devices 202, 203, and 204, and a connector hole 209. In an embodiment of the disclosure, the electronic device 200 may omit at least one (e.g., the key input devices 202, 203, and 204, the connector hole 209, or the sensor module 211) of the above-described elements, or may additionally add another element.

The display 220, for example, may be exposed through a substantial part of the front plate 201. The shape of the display 220 may be a shape corresponding to the shape of the front plate 201, and may have various shapes, such as a circle, an oval, or a polygon. The display 220 may be coupled to or disposed to be adjacent to a touch sensing circuit, a pressure sensor capable of measuring the intensity (pressure) of a touch, and/or a fingerprint sensor.

The audio modules 205 and 208 may include a microphone hole 205 and a speaker hole 208. A microphone for acquiring external sound may be disposed inside the microphone hole 205, and in an embodiment of the disclosure, a plurality of microphones may be arranged inside thereof so as to detect the direction of sound. The speaker hole 208 may be used as an external speaker and a call receiver. In an embodiment of the disclosure, the speaker hole 208 and the microphone hole 205 may be implemented as one hole, or a speaker (e.g., piezo speaker) may be provided without the speaker hole 208.

The sensor module 211 may generate an electrical signal or a data value corresponding to an internal operating state or an external environmental state of the electronic device 200. The sensor module 211 may include, for example, a biometric sensor module 211 (e.g., heart rate monitor (HRM) sensor) disposed on the second surface 210B of the housing 210. The electronic device 200 may further include a sensor module which is not shown, for example, at least one of a proximity sensor (e.g., an electrode sensor and an infrared (IR) (infrared ray) sensor), a motion sensor (e.g., an inertial sensor, an acceleration sensor, and a gyro sensor), a barometric pressure sensor, a magnetic sensor, a grip sensor, a color sensor, a biometric sensor, a temperature sensor, a humidity sensor, or an illuminance sensor.

The key input devices 202, 203, and 204 may include a wheel key 202 which is disposed on the first surface 210A of the housing 210 and is rotatable in at least one direction, and/or side key buttons 203 and 204 arranged on the side surface 210C of the housing 210. The wheel key 202 may have a shape corresponding to the shape of the front plate 201. In an embodiment of the disclosure, the electronic device 200 may not include some or all of the above-mentioned key input devices 202, 203, and 204, and the key input devices 202, 203, and 204, which are not included, may be implemented in other forms, such as a soft key, on the display 220. The connector hole 209 may include another connector hole (not shown) capable of accommodating a connector (e.g., USB connector) for transmitting and receiving power and/or data to and from an external electronic device (e.g., the external electronic device 102 or 104, or the server 108 of FIG. 1) and accommodating a connector for transmitting and receiving an audio signal to and from an external electronic device. The electronic device 200 may further include, for example, a connector cover (not shown) that covers at least a part of the connector hole 209 and blocks the inflow of foreign substances into the connector hole.

The binding members 250 and 260 may be detachably attached to at least a partial area of the housing 210 by using locking members 251 and 261. The binding members 250 and 260 may include one or more of a fixing member 252, a fixing member fastening hole 253, a band guide member 254, and a band fixing ring 255.

The fixing member 252 may be configured to fix the housing 210 and the binding members 250 and 260 to a part (e.g., wrist, ankle, or the like) of the user's body. The fixing member fastening hole 253 may fix the housing 210 and the binding members 250 and 260 to a part of the user's body to correspond to the fixing member 252. The band guide member 254 is configured to limit the range of movement of the fixing member 252 when the fixing member 252 is fastened with the fixing member fastening hole 253 so that the binding members 250 and 260 are brought into close contact with a part of the user's body to be bound thereto. The band fixing ring 255 may limit the range of movement of the binding members 250 and 260 in a state in which the fixing member 252 and the fixing member fastening hole 253 are fastened to each other.

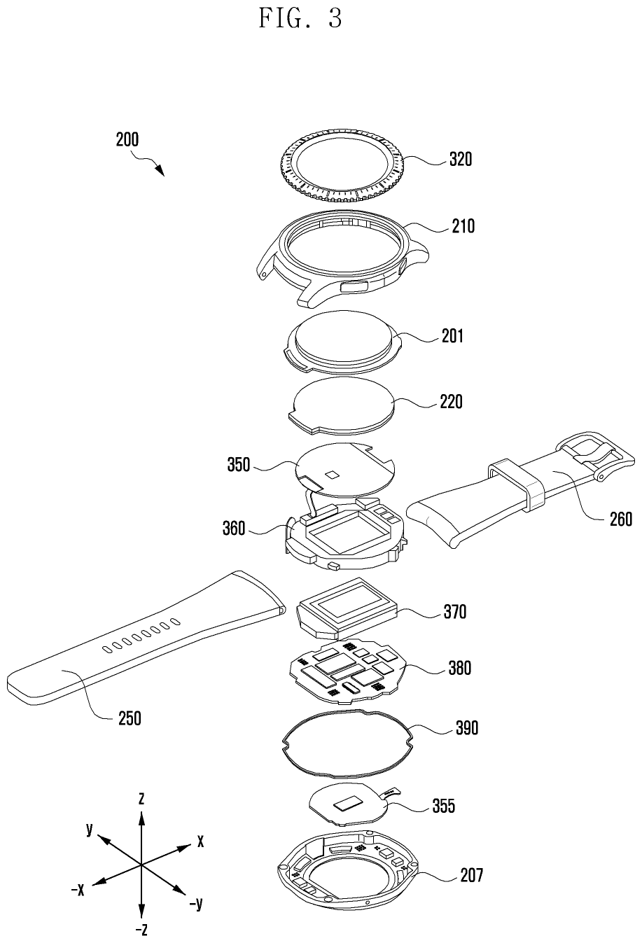

FIG. 3 is an exploded perspective view illustrating an electronic device according to an embodiment of the disclosure.

Referring to FIG. 3, the electronic device 200 may include a housing 210 (e.g., a side bezel structure), a wheel key 320, a front plate 201, a display 220, a first antenna 350, a second antenna 335, a support member 360 (e.g., a bracket), a battery 370, a printed circuit board 380, a sealing member 390, a rear plate 207, and binding members 250 and 260. At least one of the elements of the electronic device 200 may be identical or similar to at least one of the elements of the electronic device 101 shown in FIG. 1 or the electronic device 200 shown in FIGS. 2A and 2B, and a redundant description is omitted below. The support member 360 may be disposed inside the electronic device 200 and may be connected to the housing 210, or may be integrally formed with the housing 210. The support member 360 may be formed of, for example, a metal material and/or a non-metal material (e.g., polymer). The support member 360 may have one surface (e.g., z-axis direction) coupled to the display 220 (e.g., the display module 160 of FIG. 1) on and may have the other surface (e.g., −z-axis direction) coupled to the printed circuit board 380. The printed circuit board 380 may have a processor (e.g., the processor 120 of FIG. 1), memory (e.g., the memory 130 of FIG. 1), a sensor module (e.g., the sensor module 176 of FIG. 1 and or the sensor module 211 of FIG. 2B), and/or an interface (e.g., the interface 177 of FIG. 1) mounted thereon. The processor 120 may include, for example, one or more of a central processing unit, a graphics processing unit (GPU), an application processor, a sensor processor, or a communication processor.

The memory 130 may include, for example, volatile memory or non-volatile memory.

The sensor module (e.g., the sensor module 176 of FIG. 1 and/or the sensor module 211 of FIG. 2B) may include at least one of an infrared (IR) (infrared ray) sensor, an illuminance sensor, a proximity sensor, a touch sensor, an inertial sensor, a gyro sensor, an acceleration sensor, and/or a pressure sensor.

The interface 177 may include, for example, a high definition multimedia interface (HDMI), a universal serial bus (USB) interface, an SD card interface, and/or an audio interface. The interface may electrically or physically connect the electronic device 200 and an external electronic device, and may include the USB connector, the SD card/MMC connector, or the audio connector.

The battery 370 is a device for supplying power to at least one element of the electronic device 200, and may include, for example, a primary cell which is not rechargeable, a secondary cell which is chargeable, or a fuel cell. At least a part of the battery 370 may be disponed on the substantially same plane as the printed circuit board 380. The battery 370 may be integrally disposed inside the electronic device 200, and may be disposed to be attached to and detached from the electronic device 200.

The first antenna 350 may be disposed between the display 220 (e.g., the display module 160 of FIG. 1) and the support member 360. The first antenna 350 may include, for example, a near field communication (NFC) antenna, a wireless charging antenna, and/or a magnetic secure transmission (MST) antenna. The first antenna 350 may, for example, perform short-distance communication with an external device, or wirelessly transmit or receive power required for charging, and may transmit a magnetic-based signal including a short-range communication signal or payment data. In an embodiment of the disclosure, an antenna structure may be formed by a part of the housing 210 and/or the rear plate 207 or a combination thereof.

The second antenna 335 may be disposed between the printed circuit board 380 and the rear plate 207. The second antenna 335 may include, for example, a near field communication (NFC) antenna, a wireless charging antenna, and/or a magnetic secure transmission (MST) antenna. The second antenna 355 may, for example, perform short-distance communication with an external device, or wirelessly transmit or receive power required for charging, and may transmit a magnetic-based signal including a short-range communication signal or payment data. In an embodiment of the disclosure, an antenna structure may be formed by a part of the housing 210 and/or the support member 360 or a combination thereof.

The sealing member 390 may be positioned between the housing 210 and the rear plate 207. The sealing number 390 may be configured to block moisture and foreign substances from flowing into the space surrounded by the housing 210 and the rear plate 207 from the outside.

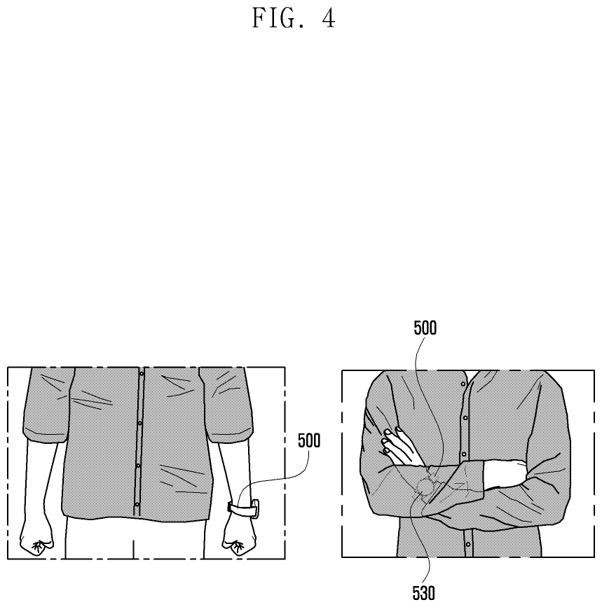

FIG. 4 illustrates a state in which an electronic device wears an electronic device according to an embodiment of the disclosure.

Referring to FIG. 4, according to various embodiments of the disclosure, an electronic device 500 may be a wristwatch-type wearable device which can be worn on the wrist of a user.

The user may wear the electronic device 500 on the left arm or the right arm. FIG. 4 illustrates a state in which the user wears the electronic device 500 on the left arm. According to an embodiment of the disclosure, the electronic device 500 may identify whether the user wears the electronic device 500 on the user's left arm or the right arm. For example, the electronic device 500 may provide a configuration menu enabling input of whether a main wearing position is the left arm or the right arm, and may identify, based on a user input on the configuration menu, a wearing position of the electronic device 500. Alternatively, the electronic device 500 may identify a pattern (or trajectory) of a movement of the electronic device 500 by using a motion sensor, and may identify, based on the movement pattern, the wearing position of the electronic device 500.

The user may wear the electronic device 500 in a forward direction or a backward direction. According to an embodiment of the disclosure, a main body and a display 530 of the electronic device 500 may have a structure symmetrical in the vertical direction, and the user may wear the electronic device 500 on the left arm or the right arm in the forward direction or the backward direction. For example, the user may wear the electronic device in the forward direction so that a first edge corresponding to the top of the main body (or the display 530) of the electronic device 500 is oriented outwardly from the user's body, or may wear the electronic device in the backward direction so that the first edge is oriented inwardly from the user's body. When the electronic device 500 is detected to be worn on the arm of the user, the electronic device 500 may identify a wearing direction and may configure a graphical user interface (GUI) corresponding to the wearing direction. For example, when the user wears the electronic device 500 in the forward direction, a background and items constituting a screen may be arranged according to the gaze of the user, and when the user wears the electronic device 500 in the forward direction, the background and the items may be arranged in a backward direction opposite to the forward direction.

Referring to FIG. 4, the user may take a posture of crossing his or her arms while wearing the electronic device 500 on the left arm. In this case, as illustrated, the display 530 of the electronic device 500 comes into contact with a part of the right arm, and the electronic device 500 may recognize the contact as a touch input. However, in this case, the user does not intend the touch input, and thus it is not desired to perform an operation (e.g., change of a watch face) according to the touch input. Accordingly, the electronic device 500 may not perform the operation according to the touch input under a designated condition even though the touch input is detected.

According to various embodiments of the disclosure, the electronic device 500 may identify, based on at least a part of whether the electronic device 500 is worn (e.g., is worn or is not worn), a wearing position (e.g., left arm or right arm), a wearing direction (e.g., forward direction or backward direction), the trajectory (e.g., distance and angle) of the movement, and/or a current angle of the electronic device 500, whether a wearing state of the electronic device 500 of the user belongs to a designated wearing state. Hereinafter, an operation in which the electronic device 500 detects, based on various information, a case where the user crosses his or her arms in various wearing states is described, but various embodiments of the disclosure are not limited thereto, and may be applied to various wearing states which may cause touch misrecognition, such as a pose in which the user puts his or her hands behind his or her back and a pose in which the user puts his or her hand in the pocket.

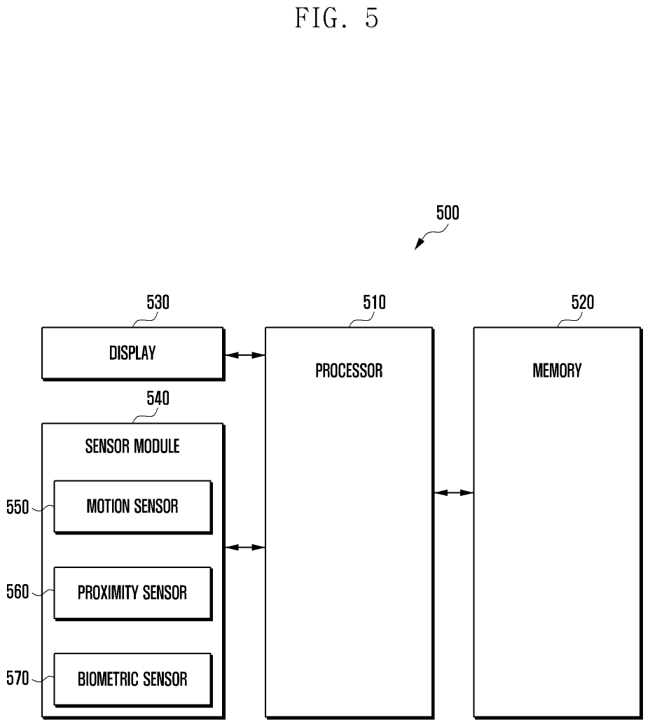

FIG. 5 is a block diagram illustrating an electronic device according to an embodiment of the disclosure.

Referring to FIG. 5, an electronic device 500 may include a display 530, a sensor module 540, a processor 510, and memory 520, and various embodiments of the disclosure may be implemented even though some of the illustrated elements are omitted or substituted. The electronic device 500 may further include the elements and/or functions of the electronic device 101 of FIG. 1.

According to various embodiments of the disclosure, the electronic device 500 may be a wristwatch-type wearable device. For example, the electronic device 500 may include, but is not limited to, the structure as in FIG. 2A, 2B, or 3.

According to various embodiments of the disclosure, the electronic device 500 may include a main body (not shown) and at least one strap (not shown). Various elements including the display 530, the sensor module 540, the processor 510, and the memory 520 may be arranged on the main body of the electronic device 500. For example, the main body may include a housing (e.g., the housing 210 of FIG. 2A), at least some elements (e.g., the processor 510, the memory 520, and a motion sensor 550) are arranged in the housing, and at least some other elements (e.g., the display 530, a proximity sensor 560, and a biometric sensor 570) may be exposed outside the housing. According to various embodiments of the disclosure, the strap is an element connected to the main body and allows the electronic device 500 to be detachably connected a body part (e.g., wrist, ankle, or the like), and may refer to a binding member (e.g., the binding members 250 and 260 of FIG. 2A).

According to various embodiments of the disclosure, the display 530 may display an image. The display 530 (or 210) may be implemented as one of a liquid crystal display (LCD), a light-emitting diode (LED) display, an organic light-emitting diode (OLED) display, a micro electro mechanical systems (MEMS) display, or an electronic paper display, but is not limited thereto.

According to various embodiments of the disclosure, the display may include a touch screen for detecting a touch input of the user. For example, the display 530 may include a capacitive touch screen, but is not limited thereto, and various types of touch screens, such as resistive or infrared touch screens, may be utilized. The display 530 may include at least a part of the elements and/or functions of the display module 160 of FIG. 1. The display 530 may be disposed on a first surface exposed to the outside when the user wears the electronic device in the main body of the electronic device 500.

According to various embodiments of the disclosure, the sensor module 540 may include various types of sensors. For example, the sensor module 540 may include a motion sensor 550, a proximity sensor 560, and/or a biometric sensor 570, the motion sensor 550 may include at least one sensor (e.g., an acceleration sensor or a gyro sensor) for detecting the movement of the electronic device 500, the proximity sensor 560 may include at least one sensor (e.g., an electrode sensor or an optical proximity sensor 560) for detecting the proximity of an external object, and/or the biometric sensor 570 may include at least one sensor (e.g., a photoplethysmography (PPG) sensor) for acquiring biometric information of the user.

According to an embodiment of the disclosure, the proximity sensor 560 may include an electrode sensor and an optical proximity sensor (or an infrared (IR) sensor). According to an embodiment of the disclosure, the electrode sensor may detect, based on a change in an electrical signal (e.g., capacitance), the contact or proximity to the user's skin. According to an embodiment of the disclosure, the optical proximity sensor 560 may include a light-emitting unit and a light-receiving unit, may detect reflection light corresponding to light output from the light-emitting unit and reflected by the user's body, and may detect, based on a detection timing and light amount of the reflection light detected by the light-receiving unit, whether the electronic device is proximate to the user's body and/or a proximity distance. According to an embodiment of the disclosure, the optical proximity sensor 560 may output light in an infrared band through the light-emitting unit, but the disclosure is not limited thereto, and the optical proximity sensor may detect proximity of an external object by using light having other wavelengths (e.g., visible light). According to an embodiment of the disclosure, to detect whether is contact with the user's body, the proximity sensor 560 may be disposed on a second surface (or an inner surface) opposite to a first surface on which the display 530 is disposed, in the body of the electronic device 500.

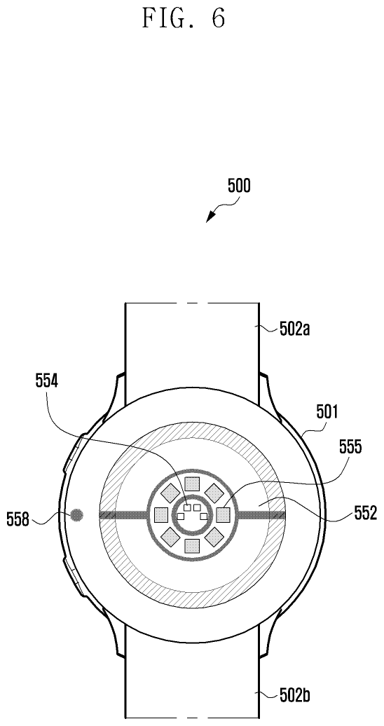

A layout structure of the proximity sensor 560 on the electronic device 500 is described through FIG. 6.

According to an embodiment of the disclosure, the motion sensor 550 may include an acceleration sensor and a gyro sensor. According to an embodiment of the disclosure, the acceleration sensor (accelerometer) may measure acceleration of the electronic device 500 in a 3-axis direction including the x axis, y axis, and z axis. According to an embodiment of the disclosure, the gyro sensor (gyroscope) may measure angular velocity of the electronic device 500 in the 3-axis direction. The processor 510 may recognize, based on sensor data of the acceleration sensor and the gyro sensor, the angle between the electronic device 500 and a current ground, and the direction and distance of the movement.

According to an embodiment of the disclosure, the biometric sensor 570 may acquire biometric sensor of the user. For example, a PPG sensor may detect the blood flow in the body through reflected light.

According to various embodiments of the disclosure, the memory 520 may include the well-known volatile memory and non-volatile memory. The memory 520 may store various instructions which can be performed by the processor 510. Such instructions may include a control instruction, such as an arithmetic and logical operation, data transfer, and input/output, which can be recognized by the processor 510. The memory 520 may include at least a part of the configuration and/or function of the memory 130 of FIG. 1, and may store at least a part of the program 140 of FIG. 1.

According to various embodiments of the disclosure, the processor 510 may perform operation or data processing for control and/or communication of the elements of the electronic device 500, and may include at least a part of the configuration of the processor 120 of FIG. 1. The processor 510 may be operatively, electrically, and/or functionally connected to the internal elements of the electronic device 500, such as the display 530, the sensor module 540, and the memory 520.

According to various embodiments of the disclosure, there is no limit to the operation and data processing function which can be implemented in the electronic device 500 by the processor 510, but in the disclosure, various embodiments in which the processor 510 detects, based on sensor data of each sensor, a touch misrecognition state of the electronic device 500 and block a touch input according to the detected touch misrecognition state are described. The operation of the processor 510 to be described below may be performed upon the execution of the instructions stored in the memory 520.

According to various embodiments of the disclosure, the processor 510 may identify, using sensor data of the sensor module 540, whether the electronic device 500 is worn on the arm of the user. According to an embodiment of the disclosure, the processor 510 may identify, using sensor data of the proximity sensor 560 (e.g., the electrode sensor or the optical proximity sensor), whether the electronic device 500 is worn. For example, when the user wears the electronic device 500, the user's skin comes into contact with the electrode sensor, and the processor 510 may identify, based on the electrical signal corresponding to a capacitance change of the electrode sensor, whether the electronic device 500 is in contact with the human body (e.g., arm). According to an embodiment of the disclosure, the processor 510 may identify, based on the electrical signal corresponding to a recognition timing and/or a light amount of the reflection light detected by the light-receiving unit of the optical proximity sensor (or the IR sensor), whether the electronic device 500 is proximate to the human body. According to an embodiment of the disclosure, the processor 510 may determine that the electronic device is proximate to the human body when all the sensor data of the electrode sensor and the optical proximity sensor satisfies a designated condition, or may determine that the electronic device is proximate to the human body when only one condition is satisfied.

According to an embodiment of the disclosure, when the proximity to the user's body is detected based on the sensor data of the electrode sensor and/or the optical proximity sensor, the processor 510 may identify a movement of the electronic device 500 by using the motion sensor 550. When a movement having a predetermined size or larger of the electronic device 500 is detected, the processor 510 may determine that the electronic device 500 is worn on the user's arm. According to an embodiment of the disclosure, when a movement having a predetermined size or larger of the electronic device 500 is not detected, the processor 510 may identify, using the biometric sensor 570, whether the user's biometric information (e.g., PPG) is detected. When the biometric information is detected, the processor 510 may determine that the electronic device is worn when the biometric information is detected, and may determine that the electronic device is not worn when the biometric information is not detected.

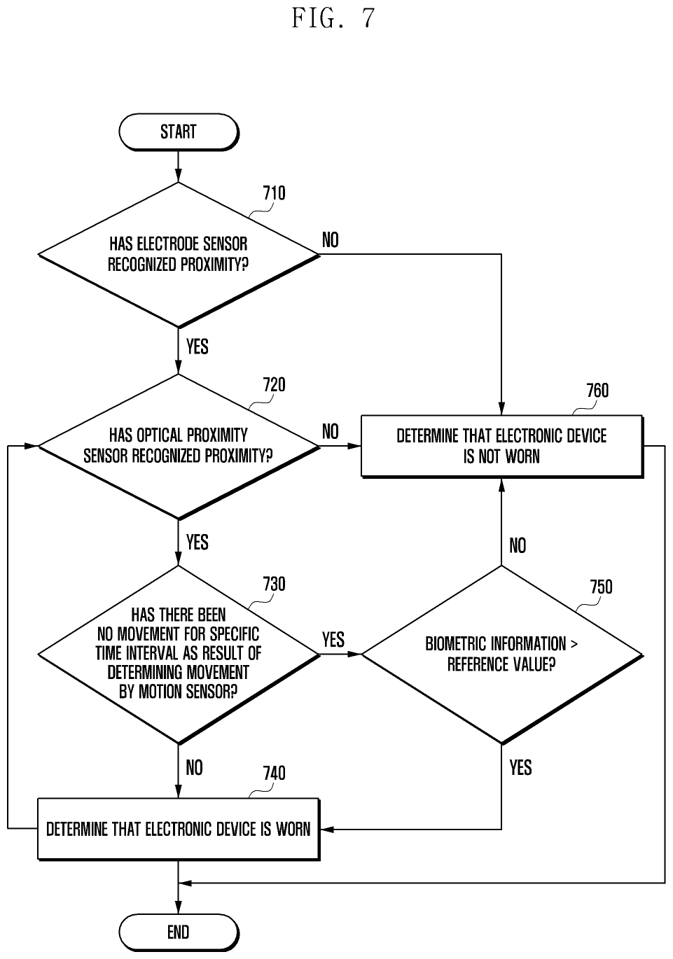

An embodiment of determining whether the electronic device 500 is worn by using sensor data of the sensor module 540 is described through FIG. 7.

According to various embodiments of the disclosure, when it is identified that the electronic device 500 is worn on the user's arm, the processor 510 may identify whether the wearing position of the electronic device 500 is the user's left arm or right arm. Generally, the user wears the electronic device 500 on an arm opposite to the user's dominant hand as the user wears a general wristwatch, and thus the user may continuously wear the electronic device 500 on one of the left arm and the right arm when wearing the electronic device. The processor 510 may provide, through the display 530, a configuration menu enabling configuration of the wearing position (e.g., left arm or right arm) of the user, and may recognize, based on the user's selection, the wearing position.

According to an embodiment of the disclosure, the processor 510 may identify, based on a pattern of the movement of the electronic device 500, whether the wearing position of the electronic device 500 is the left arm or the right arm. In a case where the user wears the electronic device 500 on the left arm and a case where the user wears the same on the right arm, the movement patterns of the electronic device 500 in the same cases may be opposite from each other in the horizontal direction. For example, in an operation in which the user walks while wearing the electronic device 500, an operation in which the user identifies display 530, an operation in which the user crosses his or her arms, or the like, in the case where the user wears the electronic device on the left arm and the case where the user wears the same on the right arm, the movement patterns thereof may be opposite from each other in the horizontal direction. The processor 510 may use the motion sensor 550 to detect such a movement pattern during the use of the electronic device 500, and may identify whether the electronic device is worn on the left arm or the right arm.

According to various embodiments of the disclosure, when it is identified that the electronic device 500 is worn on the user's arm, the processor 510 may identify whether the wearing direction of the electronic device 500 is a forward direction or a backward direction. According to an embodiment of the disclosure, the main body and the display 530 of the electronic device 500 may have a symmetrical structure in the vertical direction, and the user may wear the electronic device 500 in the forward or backward direction. For example, the user may wear the electronic device in the forward direction so that a first edge corresponding to the top of the main body (or the display 530) of the electronic device 500 is oriented outwardly from the user's body, or may wear the same in the backward direction so that the first edge is oriented inwardly from the user's body.

According to an embodiment of the disclosure, the processor 510 may identify, based on sensor data of the motion sensor 550 (e.g., the acceleration sensor), the wearing direction of the electronic device 500, and may configure a graphical user interface (GUI) corresponding to the wearing direction and display the same on the display 530. For example, the processor 510 may arrange a background and items constituting a screen according to the user's gaze when the user wears the electronic device 500 in the forward direction, and may arrange the background and items in the backward direction opposite to the forward direction when the user wears the electronic device 500 in the forward direction.

According to various embodiments of the disclosure, when the electronic device 500 is worn on the user's arm, the processor 510 may identify the movement of the electronic device 500 by using the motion sensor 550. For example, the processor 510 may identify the movement of the electronic device 500 in the 3-axis (x axis, y axis, and z axis) direction by using the acceleration sensor and the gyro sensor.

According to various embodiments of the disclosure, the processor 510 may identify whether the movement of the electronic device 500 belongs to a designated movement. Here, the designated movement may be a movement in the form which may cause a touch misrecognition state when a touch is generated on the display 530. For example, as described in FIG. 4, when the user performs an operation in which the user crosses his or her arms, the display 530 comes into contact with the opposite arm, but this may be considered as a touch misrecognition state since the user has not actually intended the touch input. The electronic device 500 may pre-store information related to various types of movements which may cause such touch misrecognition, and monitor the movement of the electronic device 500 to identify whether the movement corresponds to the designated movement.

According to an embodiment of the disclosure, when the distance of the movement of the electronic device 500 belongs to a designated distance range and the direction of the movement corresponds to a designated direction, the processor 510 may determine that the movement of the electronic device 500 belongs to the designated movement. For example, as described through FIG. 4, in a case where the user performs an operation of crossing his or her arms while putting his or her arms down, when the user wears the electronic device on the left arm in the forward direction, the electronic device 500 may move in the upper-right direction, and when the user wears the electronic device on the right arm in the forward direction, the electronic device 500 may move in the upper-left direction. In addition, the distance of the movement may be within a distance range (e.g., about more or less 1 m) corresponding to the operation in which the user crosses his or her arms. Accordingly, when the direction and the distance of the movement of the electronic device 500 corresponding to the pattern of the movement of crossing arms are detected, the processor 510 may determine that the movement corresponds to the corresponding movement.

According to an embodiment of the disclosure, when the size of the movement is within a designated size after the electronic device 500 moves within a designated distance range, the processor 510 may determine that the movement of the electronic device 500 belongs to the designated movement. For example, in the operation of crossing arms, the positions of the arms remain for a predetermined time interval or longer after the movement occurs, and thus the movement of the electronic device 500 may remain within the designated size.

According to various embodiments of the disclosure, when the movement of the electronic device 500 corresponds to the designated movement, the processor 510 may identify whether the angle at which the electronic device 500 is tilted belongs to a designated angle range. According to an embodiment of the disclosure, the processor 510 may identify whether the wearing position of the electronic device 500 is the forward direction or the backward direction, may identify whether the angle at which the electronic device 500 is tilted is within a first angle range when the wearing direction is the forward direction, and may identify whether the angle at which the electronic device 500 is titled is within a second angle range when the wearing direction is the backward direction. For example, when the user performs an operation of crossing his or her arms, the direction of the display 530 of the electronic device 500 may be an opposite direction from the user's body, and the angle thereof may be about 30 degrees to 80 degrees with respect to the vertical direction of the user's gaze. In this case, when the user wears the electronic device 500 in the forward direction, angle information acquired by the motion sensor 550 (or the acceleration sensor) may be 30 degrees to 80 degrees, and when the user wears the electronic device in the backward direction, angle information acquired by the motion sensor 550 may be 280 degrees to 330 degrees. Accordingly, the electronic device 500 may designate a first angle range as 30 degrees to 80 degrees and designate a second angle range as 280 degrees to 330 degrees according to the angle at which the electronic device 500 is tilted when the user performs the operation of crossing his or her arms.

According to various embodiments of the disclosure, when the angle at which the electronic device 500 is titled is within the designated angle range, the processor 510 may determine a touch misrecognition state. Here, the touch misrecognition state may correspond to, as described in FIG. 4, a state in which there is high possibility that a detected touch input is a touch which is actually not intended by the user, and as described above, the processor 510 may determine the touch misrecognition state according to whether the movement of the electronic device 500 corresponds to the designated movement and/or whether the angle at which the electronic device 500 is tilted is within a designated angle range.

According to various embodiments of the disclosure, when the movement and the tilted angle of the electronic device 500 satisfies a touch misrecognition condition, the processor 510 may identify the area of a touch input when a touch input to the display 530 is detected, and may determine the touch misrecognition state when the area of the touch input is equal to or greater than the designated size. For example, in a case of the operation of crossing arms, the area of the touch on the display 530 by the arms is large, and thus the electronic device 500 may not process the operation for the touch input when the touch having the area equal to or larger than a reference area.

According to various embodiments of the disclosure, when the movement and the tilted angle of the electronic device 500 satisfies a touch misrecognition condition, the processor 510 may determine the touch misrecognition state when a touch input to the display 530 is detected. For example, in a case of the operation of crossing arms, the electronic device 500 may not process the operation for the touch input when the touch is detected.

According to various embodiments of the disclosure, when determining the touch misrecognition state, the processor 510 may not execute the operation corresponding to the touch input detected on the display 530. For example, the processor 510 may be pre-configured to execute an operation of changing a watch face during a long touch input on the display 530. When the touch misrecognition state is determined, the processor 510 may not perform the pre-designated operation, such as the change of the watch face even though the touch input is detected. According to an embodiment of the disclosure, when the touch misrecognition state is determined, the processor 510 may not process the touch input received from the display 530 (or a touch IC), and/or may transmit, to the display 530, a command for refraining from transmitting touch information to the processor 510.

According to an embodiment of the disclosure, when the touch misrecognition state is determined, the processor 510 may display a touch lock screen on the display 530. Here, the touch lock screen may mean a screen on which general operation control, such as execution of an application is not provided except for a designated function, such as unlocking, such as an unlock screen.

According to an embodiment of the disclosure, when the touch input is detected for a predetermined time interval in the touch misrecognition state, the processor 510 may provide information indicating that the operation according to the touch input is not performed to the user through vibration by means of a haptic module or sound output by means of a speaker.

FIG. 6 illustrates various sensors arranged in a main body of an electronic device according to an embodiment of the disclosure.

Referring to FIG. 6, according to various embodiments of the disclosure, an electronic device 500 may include a proximity sensor (e.g., the proximity sensor 560 of FIG. 5) for detecting an approaching external object. The proximity sensor may include an electrode sensor 552 for detecting, based on a change in an electrical signal (e.g., capacitance), contact or proximity to the user's skin and/or an optical proximity sensor for detecting, through a light-receiving unit 555, reflection light corresponding to light output from a light-emitting unit 554 and reflected by the user's body, and detecting, based on a detection timing and light amount of the reflection light detected by the light-receiving unit 555, whether the electronic device is proximate to the user's body and/or a proximity distance.

According to various embodiments of the disclosure, the electronic device 500 may include a main body 501 and one or more straps 502a and 502b. The display may be disposed in a first direction of the main body 501 of the electronic device 500, and the proximity sensor (e.g., the electrode sensor 552 and the light-emitting unit 554 and the light-receiving unit 555 of the optical proximity sensor) may be disposed in a second direction of the main body 501. Here, the first direction may be a direction exposed externally when the user wears the electronic device 500, and the second direction may be a direction oriented to the user's body.

FIG. 6 illustrates a second surface in a second direction of the electronic device 500, which faces the human body when the user wears the same.

Referring to FIG. 6, the electrode sensor 552, the light-emitting unit 554 and the light-receiving unit 555 of the optical proximity sensor, and a temperature sensor 558 may be arranged on the second surface of the electronic device 500.

According to an embodiment of the disclosure, the electrode sensor 552 may detect a change in an electrical signal generated when contacting the user's skin. The electrode sensor 552 using the electrical characteristics of the skin may include at least one electrode and an electric circuit, and may determine whether there is contact by detecting a difference in capacitance and/or the flow of microcurrents that occur when the skin touches the electrode.

According to an embodiment of the disclosure, the optical proximity sensor may include at least one light-emitting unit 554 and at least one light-receiving unit 555. Referring to FIG. 6, the light-receiving unit 554 may include at least one LED which can output light in at least one wavelength band (e.g., red, green, blue, or IR). The light-receiving unit 555 may be disposed to be adjacent to the light-emitting unit 554, and may include at least one photo-diode for detecting reflection light. FIG. 6 illustrates that multiple light-receiving units 555 are arranged in a circle shape at the outer side of the light-emitting unit 554, but the layout of the light-emitting unit 554 and the light-receiving unit 555 is not limited thereto.

According to an embodiment of the disclosure, the optical proximity sensor may output light through the light-emitting unit 554 and may detect, based on the strength (or the light amount) of the reflection light reflected from the user's body, detected by the light-receiving unit 555, whether the electronic device is proximate. The light-emitting unit 554 may output light in an infrared (IR) band, most objects absorb light in an IR wavelength band while a skin cell the same most part, and the electronic device 500 may determine whether the electronic device is proximate to the user body by using such a difference.

According to an embodiment of the disclosure, a biometric sensor (not shown) may be further disposed on the second surface of the main body 501. For example, the electronic device 500 may include a photoplethysmography (PPG) sensor for detecting the change in the blood flow of human.

FIG. 7 is a flowchart illustrating a method for determining whether an electronic device is worn according to an embodiment of the disclosure.

Referring to FIG. 7, the illustrated method may be performed by an electronic device (e.g., the electronic device 500 of FIG. 5), and the description of the technical features, which have been described above, will be omitted below.

According to various embodiments of the disclosure, in operation 710, an electronic device may identify whether the electronic device is proximate to a user's body by using an electrode sensor (e.g., the electrode sensor 552 of FIG. 6). The electrode sensor may be disposed on a surface opposite to a display in a main body (e.g., the main body 501 of FIG. 6) of the electronic device, i.e., a surface coming into contact with the user's arm when the electronic device is worn. The electrode sensor may determine whether the electronic device is proximate (or is in contact) by detecting a difference in capacitance and/or the flow of microcurrents that occur when the skin touches the electrode. When a change in the electrical signal is not detected by the electrode sensor, the electronic device may determine, in operation 760, a state in which the electronic device is not worn.

According to various embodiments of the disclosure, in operation 720, the electronic device may identify whether the electronic device is proximate to the user's body by using an optical proximity sensor (e.g., an IR sensor). The optimal proximate sensor may output light through a light-emitting unit (e.g., the light-emitting unit 554 of FIG. 6) and detect, based on the strength (or light amount) of reflection light detected by a light-receiving unit (e.g., the light-receiving unit 555 of FIG. 6) and reflected by the user's skin, whether the electronic device is proximate. When the strength of reflection light detected by the optical proximity sensor has a value smaller than a reference value, the electronic device may determine, in operation 760, a state in which the electronic device is not worn. FIG. 7 illustrates that operations 710 and 720 are subsequently performed, but the disclosure is not limited thereto, and the order may change and/or at least a part thereof may be simultaneously performed.

According to various embodiments of the disclosure, in operation 730, the electronic device may detect a movement of the electronic device by using a motion sensor, and identify whether there is no movement for a specific time interval or longer. When there is a movement of the electronic device as a result of the identification, the electronic device may determine that the electronic device is won on the user's am in operation 740.

According to various embodiments of the disclosure, when there is no movement of the electronic device as a result of the identification in operation 730, the electronic device may identify biometric information by using a biometric sensor (e.g., a PPG sensor) and identify whether the biometric information indicates a value greater than a reference value, in operation 750. When the biometric information (PPG SNR) indicates a value greater than the reference value as a result of the identification, the electronic device may determine, in operation 740, that the electronic device is currently worn on the user's arm. On the other hand, when the biometric information (PPG SNR) indicates a value equal to or smaller than the reference value, the electronic device may determine, in operation 760, a state in which the electronic device is not worn.

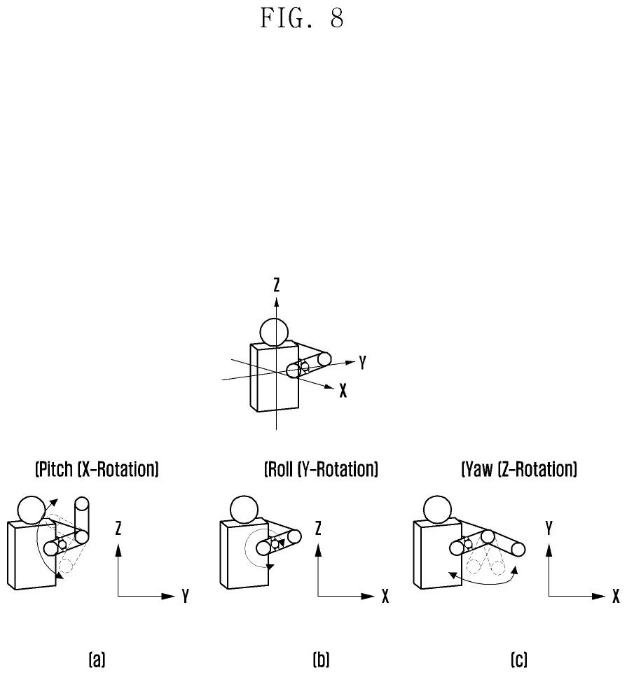

FIG. 8 illustrates a movement detection direction of a motion sensor of an electronic device according to an embodiment of the disclosure.

Referring to FIG. 8, according to various embodiments of the disclosure, an electronic device (e.g., the electronic device 500 of FIG. 5) may include a motion sensor (e.g., the motion sensor 550 of FIG. 5) for detecting a movement of the electronic device. For example, the motion sensor may include an acceleration sensor and a gyro sensor. According to an embodiment of the disclosure, the acceleration sensor (accelerometer) may measure acceleration of the electronic device in a 3-axis direction including the x axis, y axis, and z axis. For example, the acceleration sensor may detect moving acceleration in three axes (x axis, y axis, and z axis) in a space by using a 3-axis acceleration detection sensor so as to detect a movement of the electronic device having an acceleration sensor mounted therein, such as a positional change including a drop or spontaneous horizontal/vertical movement. The acceleration sensor may identify (or measure or detect) the acceleration of the electronic device in the 3-axis direction of the x axis, y axis, and z axis, and may output moving data of each 3-axis direction to a processor.

According to an embodiment of the disclosure, the gyro sensor (gyroscope) may measure angular velocity of the electronic device in the 3-axis direction. The angular velocity may be configured to be proportional to the degree and/or velocity of the movement detected by the motion sensor.

Referring to FIG. 8, the motion sensor may detect the movement of the user in the 3-axis direction including the x axis, y axis, and z axis. For example, as shown in part (a) of FIG. 8, when the user swings his or her arm in the clockwise or counterclockwise direction in parallel to his or her torso while wearing the electronic device, a pitch operation (or an x-axis rotation) may be detected. Alternatively, as shown in part (b) of FIG. 8, when the user swings his or her arm perpendicular to his or her torso while wearing the electronic device, a roll operation (or a y-axis rotation) may be detected. Alternatively, as shown in part (c) of FIG. 8, when the user swings his or her arm from the left to the right while wearing the electronic device, a yaw operation (or a z-axis rotation) may be detected.

According to an embodiment of the disclosure, when the movement is detected, the motion sensor (e.g., the acceleration sensor or the gyro sensor) may convert movement information into the form of a signal and output the same to the processor. When a movement of a sudden change in the position of the electronic device, such as spontaneous horizontal or vertical moving, occurs from the sensor data of the motion sensor, the processor may detect a signal which is proportional to the movement, and convert the detected movement information into a designated signal form.

According to various embodiments of the disclosure, the electronic device may identify whether the movement of the electronic device belongs to a designated movement. For example, the electronic device may identify whether the movement is a movement corresponding to the operation of crossing arms in FIG. 4. According to an embodiment of the disclosure, the electronic device may identify whether a current wearing position (e.g., left arm or right arm) and/or a wearing position (e.g., forward direction or backward direction) of the electronic device, and may identify whether the movement corresponds to the designated movement based on the wearing position and/or the wearing direction.

According to an embodiment of the disclosure, the electronic device may identify whether a movement occurs in a designated distance and a designated direction with reference to the current position by using the motion sensor. For example, when the user performs an operation of crossing his or her arms while wearing the electronic device on his or her arm, the electronic device may move in the upper-right direction and the distance of the movement may be about 1 m. In addition, when the user performs an operation of crossing his or her arms while wearing the electronic device on his right arm, the electronic device may move in the upper-left direction and the distance of the movement may be about 1 m. The electronic device may identify whether the movement of the electronic device corresponds to a designated direction and a designated distance according to the wearing position of the user.

According to an embodiment of the disclosure, when the size of the movement is within a designated size for a designated time interval or longer after the electronic device moves within a designated distance range, the electronic device may determine that the movement of the electronic device belongs to a designated movement.

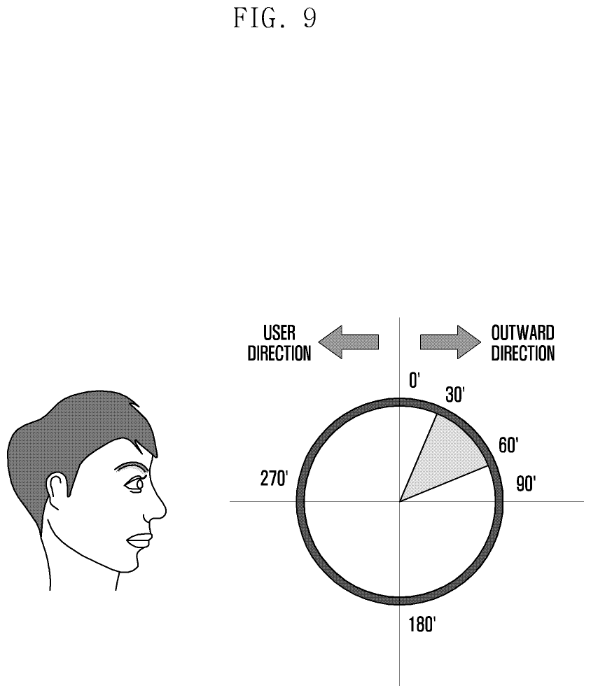

FIG. 9 simply illustrates an angle at which an electronic device is oriented according to an embodiment of the disclosure.

Referring to FIG. 9, according to various embodiments of the disclosure, when a movement of an electronic device (e.g., the electronic device 500 of FIG. 5) corresponds to a designated movement, the electronic device may identify whether an angle at which the electronic device is tilted belongs to a designated angle range. According to an embodiment of the disclosure, the electronic device may identify whether a wearing direction of the electronic device is a forward direction or a backward direction, may identify whether the angle at which the electronic device is tilted is within a first angle range when the wearing direction is the forward direction, and may identify whether the angle at which the electronic device is titled is within a second angle range when the wearing direction is the backward direction.

Referring to FIG. 9, when the user performs an operation of crossing his or her arms while wearing the electronic device, the direction in which a main body or a display of the electronic device is oriented corresponds to an outward direction which is opposite to a user direction, and the angle thereof may be between 30 to 80 degrees with reference to the perpendicular direction (or the direction perpendicular to the ground) of the user's gaze, i.e., a case where the direction toward the sky is designated as 0 degrees. In this case, angle information acquired by the motion sensor (or the acceleration sensor) may be 30 to 80 degrees when the user wears the electronic device in the forward direction, and angle information acquired by the motion sensor may be 280 to 330 degrees when the user wears the electronic device in the backward direction. Accordingly, the electronic device may designate a first angle range as 30 to 80 degrees and designate a second angle range as 280 to 330 degrees according to the angle at which the electronic device is tilted while performing the operation of crossing arms.

According to an embodiment of the disclosure, when identifying the wearing position as the forward direction, the electronic device may identify whether the angle at which the main body or the display of the electronic device is tilted is within a first angle range (e.g., 30 to 80 degrees). According to an embodiment of the disclosure, when identifying the wearing direction is the backward direction, the electronic device may identify whether the angle at which the main body or the display of the electronic device is titled is within a first angle range (e.g., 280 to 330 degrees).

According to various embodiments of the disclosure, the processor may determine a touch misrecognition state when the angle at which the electronic device is titled is within the designated first angle range or second angle range.

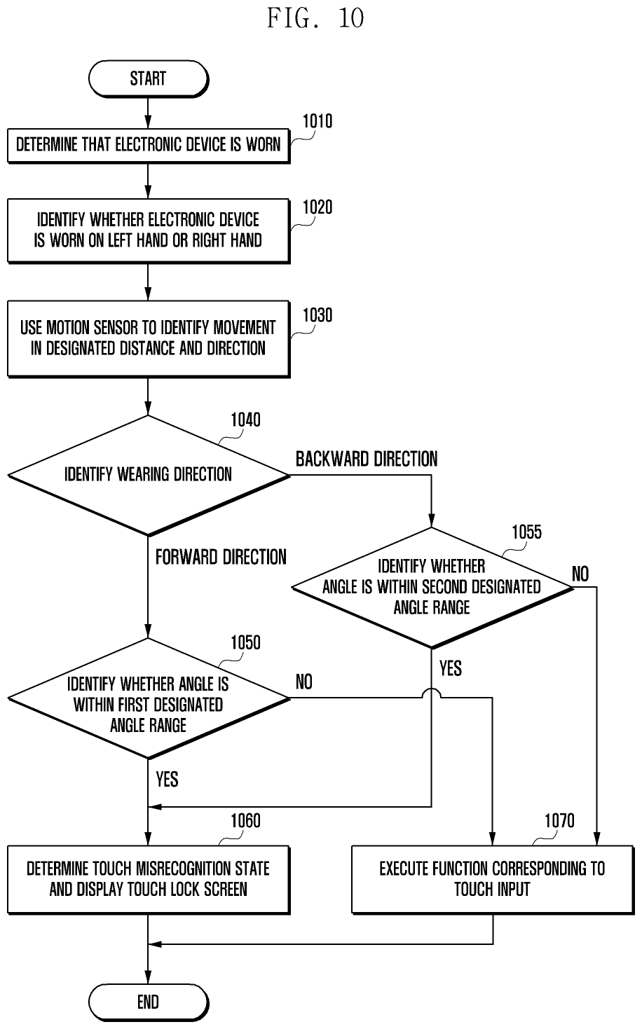

FIG. 10 is a flowchart illustrating a touch malfunction detection method of an electronic device according to an embodiment of the disclosure.

Referring to FIG. 10, the illustrated method may be performed by an electronic device (e.g., the electronic device 500 of FIG. 5), and the description of technical features, which have been described above, will be omitted below.

According to various embodiments of the disclosure, in operation 1010, an electronic device may identify whether the electronic device is worn on a user's arm. For example, the electronic device may identify whether the electronic device is worn by using sensor data of a proximity sensor (e.g., an electrode sensor or an optical proximity sensor), and may further use sensor data of a motion sensor and/or a biometric sensor. The method for identifying whether the electronic device is worn has been described above through FIG. 7.

According to various embodiments of the disclosure, in operation 1020, the electronic device may identify whether a wearing position of the electronic device is a user's left arm or right arm. According to an embodiment of the disclosure, a configuration menu enabling configuration of a wearing position (e.g., left arm or right arm) of the user may be provide through a display, and the wearing position may be recognized based on the user's selection. According to another embodiment of the disclosure, the electronic device may identify, based on a movement pattern of the electronic device, identified using the motion sensor, whether the wearing position of the electronic device is a left arm or a right arm.

According to various embodiments of the disclosure, in operation 1030, the electronic device may identify a movement of the electronic device by using the motion sensor and may identify, based on whether the movement of the electronic device belongs to a designated distance and/or a designated direction, whether the movement of the electronic device belongs to a designated movement. Here, the designated movement may be a movement in the form which may cause a touch misrecognition state when a touch is generated on the display. For example, in a case where the designated movement is an operation of crossing arms, when the user wears the electronic device on the left arm in the forward direction, the electronic device may move in the upper-right direction, and when the user wears the electronic device on the left arm in the forward direction, the electronic device may move in the upper-left direction. In addition, the distance of the movement may be within a distance range (e.g., about more or less 1 m) corresponding to an operation in which the user crosses his or her arms. Accordingly, when detecting the direction and the distance of the movement of the electronic device, which corresponds to an arm crossing movement pattern, is detected, the electronic device may determine that the movement corresponds to the corresponding movement.

According to an embodiment of the disclosure, the designated movement is not limited to the operation of crossing arms, and the electronic device may pre-store information related to various types of movements which may cause touch misrecognition, and monitor the movement of the electronic device to identify whether the movement corresponds to a designated movement.

According to various embodiments of the disclosure, in operation 1040, the electronic device may identify whether the wearing direction of the electronic device is a forward direction or a backward direction. When the wearing direction is the forward direction, the electronic device may identify, in operation 1050, whether the angle at which the electronic device is titled is within a first angle range. Here, the first angle range may be 30 to 80 degrees, but the disclosure is not limited thereto. When the wearing direction is the backward direction, the electronic device may identify, in operation 1055, whether the angle at which the electronic device is tilted is within a second angle range. Here, the second angle range may be 280 to 330 degrees, but the disclosure is not limited thereto, and a sum of the second angle range and the first angle range may be determined to be 360 degrees.

According to various embodiments of the disclosure, when the angle at which the electronic device is titled belongs to the first angle range or the second angle range, the electronic device may determine a touch misrecognition state in operation 1060. In the touch misrecognition state, the electronic device may display a touch lock screen (or lock screen) and may not execute an operation corresponding to a touch input. When the angle at which the electronic device is titled does not belong to the first angle range or the second angle range, the electronic device may execute a function corresponding to the touch input in operation 1070.

An electronic device according to various embodiments of the disclosure may include a display including a touch screen, a proximity sensor configured to detect an approaching external object, a motion sensor configured to detect a movement of the electronic device, and a processor operatively connected to the display, the proximity sensor, and the motion sensor.

According to various embodiments of the disclosure, the processor may use the proximity sensor to identify whether the electronic device is worn on an arm of a user.

According to various embodiments of the disclosure, in case that the electronic device is worn on the arm of the user, the processor may use the motion sensor to identify a movement of the electronic device, and identify whether the identified movement of the electronic device belongs to a designated movement.

According to various embodiments of the disclosure, in case that the movement belongs to the designated movement, the processor may be configured to identify whether an angle at which the electronic device is tilted belongs to a designated angle range, determine, at least based on whether the angle at which the electronic device is tilted is within the designated range, a touch misrecognition state, and in case of the touch misrecognition state, refrain from executing an operation corresponding to a touch input detected on the display.

According to various embodiments of the disclosure, the electronic device may include a main body and a strap, wherein the display is disposed in a first direction of the main body, and the proximity sensor is disposed in a second direction of the main body.

According to various embodiments of the disclosure, the electronic device may further include a biometric sensor configured to detect biometric information of the user, wherein the processor is configured to in case that proximity of an external object is detected through the proximity sensor, identify the movement of the electronic device through the motion sensor, in case that the proximity of the electronic device is not detected, use the biometric sensor to identify biometric information, and in case that the biometric information is identified, determine that the electronic device is worn on the arm of the user.

According to various embodiments of the disclosure, the processor may be configured to in case that a distance of the movement of the electronic device belongs to a designated distance range and a direction of the movement of the electronic device corresponds to a designated direction, determine that the movement of the electronic device belongs to the designated movement.

According to various embodiments of the disclosure, the processor may be configured to in case that the electronic device is identified to be worn on the arm of the user, identify, based on pre-stored configuration information or a pattern of the movement of the electronic device, whether the electronic device is worn on a left arm or a right arm of the user.

According to various embodiments of the disclosure, the processor may be configured to in case that the electronic device is identified to be worn on the left arm of the user, identify whether the electronic device moves in a first direction, and in case that the electronic device is identified to be worn on the right arm of the electronic device, identify whether the electronic device moves in a second direction opposite to the first direction.

According to various embodiments of the disclosure, the processor may be configured to in case that a size of the movement is within a designated size for a designated time interval or longer after the electronic device moves within the designated distance range, determine that the movement of the electronic device belongs to the designated movement.

According to various embodiments of the disclosure, the processor may be configured to identify, based on the pre-stored configuration information or the pattern of the movement of the electronic device, whether a wearing direction of the electronic device is a forward direction or a backward direction.

According to various embodiments of the disclosure, the processor may be configured to in case that the wearing direction of the electronic device is the forward direction, identify whether the angle at which the electronic device is tilted is within a first angle range, and in case that the wearing direction of the electronic device is the backward direction, identify whether the angle at which the electronic device is tilted is within a second angle range.

According to various embodiments of the disclosure, the processor may be configured to in case that the angle at which the electronic device is tilted is within the designated angle range and an area of a touch input to the display is equal to or greater than a designated size, determine the touch misrecognition state.

According to various embodiments of the disclosure, the processor may be configured to in case that the touch misrecognition state is determined, display a touch lock screen.

According to various embodiments of the disclosure, the motion sensor may include an acceleration sensor and a gyro sensor.

A touch misrecognition detection method of an electronic device according to various embodiments of the disclosure may include using a proximity sensor to identify whether the electronic device is worn on an arm of a user, in case that the electronic device is worn on the arm of the user, using a motion sensor to identify a movement of the electronic device, identifying whether the identified movement of the electronic device belongs to a designated movement, in case that the movement belongs to the designated movement, identifying whether an angle at which the electronic device is tilted belongs to a designated angle range, and determining, at least based on whether the angle at which the electronic device is tilted is within the designated range, a touch misrecognition state.

According to various embodiments of the disclosure, the method may include in case of the touch misrecognition state, refraining from executing an operation corresponding to a touch input detected on the display.

According to various embodiments of the disclosure, the identifying of whether the electronic device is worn on the arm of the user may include in case that proximity of an external object is detected through the proximity sensor, identifying the movement of the electronic device through the motion sensor, in case that the proximity of the electronic device is not detected, using the biometric sensor to identify biometric information, and in case that the biometric information is identified, determining that the electronic device is worn on the arm of the user.

According to various embodiments of the disclosure, the identifying of whether the movement corresponds to the designated movement may include in case that a distance of the movement of the electronic device belongs to a designated distance range and a direction of the movement of the electronic device corresponds to a designated direction, determining that the movement of the electronic device belongs to the designated movement.

According to various embodiments of the disclosure, the method may further include in case that the electronic device is identified to be worn on the arm of the user, identifying, based on pre-stored configuration information or a pattern of the movement of the electronic device, whether the electronic device is worn on a left arm or a right arm of the user.

According to various embodiments of the disclosure, the identifying of whether the movement corresponds to the designated movement may include in case that the electronic device is identified to be worn on the left arm of the user, identifying whether the electronic device moves in a first direction, and in case that the electronic device is identified to be worn on the right arm of the electronic device, identifying whether the electronic device moves in a second direction opposite to the first direction.

According to various embodiments of the disclosure, the identifying of whether the movement belongs to the designated movement may include in case that a size of the movement is within a designated size for a designated time interval or longer after the electronic device moves within the designated distance range, determining that the movement of the electronic device belongs to the designated movement.

According to various embodiments of the disclosure, the method may further include identifying, based on the pre-stored configuration information or the pattern of the movement of the electronic device, whether a wearing direction of the electronic device is a forward direction or a backward direction.

According to various embodiments of the disclosure, the identifying of whether the angle at which the electronic device is tilted belongs to a designated angle range may include in case that the wearing direction of the electronic device is the forward direction, identifying whether the angle at which the electronic device is tilted is within a first angle range, and in case that the wearing direction of the electronic device is the backward direction, identifying whether the angle at which the electronic device is tilted is within a second angle range.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display comprising a touch screen;
a proximity sensor configured to detect an approaching external object;
a motion sensor configured to detect a movement of the electronic device;
memory storing one or more computer programs; and
a processor communicatively coupled to the display, the proximity sensor, the motion sensor, and the memory,
wherein the one or more computer programs include computer-executable instructions that, when executed by the processor, cause the electronic device to:
use the proximity sensor to identify whether the electronic device is worn on an arm of a user,
in case that the electronic device is worn on the arm of the user, use the motion sensor to identify a movement of the electronic device,
identify whether the identified movement of the electronic device belongs to a designated movement,
in case that the identified movement belongs to the designated movement, identify whether an angle at which the electronic device is tilted falls within a designated angle range,
determine, at least based on whether the angle at which the electronic device is tilted is within the designated angle range, that the electronic device is in a touch misrecognition state, and
in case that the electronic device is in the touch misrecognition state, refrain from executing an operation corresponding to a touch input detected on the display.

2. The electronic device of claim 1,
wherein the electronic device comprises a main body and a strap, and
wherein the display is disposed in a first direction of the main body and the proximity sensor is disposed in a second direction of the main body.

3. The electronic device of claim 1, further comprising:
a biometric sensor configured to detect biometric information of the user,
wherein the one or more computer programs further include computer-executable instructions that, when executed by the processor, cause the electronic device to:
in case that proximity of an external object is detected through the proximity sensor, identify the movement of the electronic device through the motion sensor,
in case that the proximity of the electronic device is not detected, use the biometric sensor to identify biometric information, and
in case that the biometric information is identified, determine that the electronic device is worn on the arm of the user.

4. The electronic device of claim 1, wherein the one or more computer programs further include computer-executable instructions that, when executed by the processor, cause the electronic device to, in case that a distance of the movement of the electronic device falls within a designated distance range and a direction of the movement of the electronic device corresponds to a designated direction, determine that the movement of the electronic device belongs to the designated movement.

5. The electronic device of claim 2, wherein the one or more computer programs further include computer-executable instructions that, when executed by the processor, cause the electronic device to, in case that the electronic device is identified to be worn on the arm of the user, identify, based on pre-stored configuration information or a pattern of the movement of the electronic device, whether the electronic device is worn on a left arm or a right arm of the user.

6. The electronic device of claim 5, wherein the one or more computer programs further include computer-executable instructions that, when executed by the processor, cause the electronic device to:
in case that the electronic device is identified to be worn on the left arm of the user, identify whether the electronic device moves in the first direction; and
in case that the electronic device is identified to be worn on the right arm of the electronic device, identify whether the electronic device moves in the second direction opposite to the first direction.

7. The electronic device of claim 4, wherein the one or more computer programs further include computer-executable instructions that, when executed by the processor, cause the electronic device to, in case that a size of the movement is within a designated size for a designated time interval or longer after the electronic device moves within the designated distance range, determine that the movement of the electronic device belongs to the designated movement.

8. The electronic device of claim 5, wherein the one or more computer programs further include computer-executable instructions that, when executed by the processor, cause the electronic device to identify, based on the pre-stored configuration information or the pattern of the movement of the electronic device, whether a wearing direction of the electronic device is a forward direction or a backward direction.

9. The electronic device of claim 8, wherein the one or more computer programs further include computer-executable instructions that, when executed by the processor, cause the electronic device to:
in case that the wearing direction of the electronic device is the forward direction, identify whether the angle at which the electronic device is tilted is within a first angle range; and
in case that the wearing direction of the electronic device is the backward direction, identify whether the angle at which the electronic device is tilted is within a second angle range.

10. The electronic device of claim 1, wherein the one or more computer programs further include computer-executable instructions that, when executed by the processor, cause the electronic device to, in case that the angle at which the electronic device is tilted is within the designated angle range and an area of a touch input to the display is equal to or greater than a designated size, determine that the electronic device is in the touch misrecognition state.

11. A touch misrecognition detection method of an electronic device, the method comprising:
using a proximity sensor to identify whether the electronic device is worn on an arm of a user;
in case that the electronic device is worn on the arm of the user, using a motion sensor to identify a movement of the electronic device;
identifying whether the identified movement of the electronic device belongs to a designated movement;
in case that the identified movement belongs to the designated movement, identifying whether an angle at which the electronic device is tilted falls within a designated angle range;
determining, at least based on whether the angle at which the electronic device is tilted is within the designated angle range, that the electronic device is in a touch misrecognition state; and
in case that the electronic device is in the touch misrecognition state, refraining from executing an operation corresponding to a touch input detected on a display including a touch screen.

12. The method of claim 11, wherein the identifying of whether the movement belongs to the designated movement comprises, in case that a distance of the movement of the electronic device falls within a designated distance range and a direction of the movement of the electronic device corresponds to a designated direction, determining that the movement of the electronic device belongs to the designated movement.

13. The method of claim 11, further comprising, in case that the electronic device is identified to be worn on the arm of the user, identifying, based on pre-stored configuration information or a pattern of the movement of the electronic device, whether the electronic device is worn on a left arm or a right arm of the user.

14. The method of claim 13, wherein the identifying of whether the movement belongs to the designated movement comprises:
in case that the electronic device is identified to be worn on the left arm of the user, identifying whether the electronic device moves in a first direction; and
in case that the electronic device is identified to be worn on the right arm of the electronic device, identifying whether the electronic device moves in a second direction opposite to the first direction.

15. The method of claim 12, wherein the identifying of whether the movement corresponds to the designated movement comprises, in case that a size of the movement is within a designated size for a designated time interval or longer after the electronic device moves within the designated distance range, determining that the movement of the electronic device belongs to the designated movement.

16. The method of claim 13, further comprising:
identifying, based on the pre-stored configuration information or the pattern of the movement of the electronic device, whether a wearing direction of the electronic device is a forward direction or a backward direction.

17. The method of claim 16, further comprising:
in case that the wearing direction of the electronic device is the forward direction, identifying whether the angle at which the electronic device is tilted is within a first angle range; and
in case that the wearing direction of the electronic device is the backward direction, identifying whether the angle at which the electronic device is tilted is within a second angle range.

18. The method of claim 11, further comprising:
in case that the angle at which the electronic device is tilted is within the designated angle range and an area of a touch input to the display is equal to or greater than a designated size, determining that the electronic device is in the touch misrecognition state.

19. One or more non-transitory computer-readable storage media storing one or more computer programs including computer-executable instructions that, when executed by one or more processors of an electronic device individually or collectively, cause the electronic device to perform operations including a touch misrecognition detection method, the operations comprising:
using a proximity sensor to identify whether the electronic device is worn on an arm of a user;
in case that the electronic device is worn on the arm of the user, using a motion sensor to identify a movement of the electronic device;
identifying whether the identified movement of the electronic device belongs to a designated movement;
in case that the identified movement belongs to the designated movement, identifying whether an angle at which the electronic device is tilted falls within a designated angle range;
determining, at least based on whether the angle at which the electronic device is tilted is within the designated angle range, that the electronic device is in a touch misrecognition state; and
in case that the electronic device is in the touch misrecognition state, refraining from executing an operation corresponding to a touch input detected on a display including a touch screen.

20. The one or more non-transitory computer-readable storage media of claim 19, wherein the identifying of whether the movement belongs to the designated movement comprises, in case that a distance of the movement of the electronic device falls within a designated distance range and a direction of the movement of the electronic device corresponds to a designated direction, determining that the movement of the electronic device belongs to the designated movement.
